(19) United States
(12) Patent Application Publication
(10) Pub. No.: US 2026/0297901 A1
(43) Pub. Date: Oct. 1, 2026

(54) Hydraulic System, Work Vehicle, Control Method, and Computer Program

(71) Applicant: Kubota Corporation, Osaka-shi (JP)

(72) Inventor: Yasuhiro Manji, Sakai-shi (JP)

(21) Appl. No.: 19/401,853

(22) Filed: Nov. 26, 2025

(30) Foreign Application Priority Data
Dec. 2, 2024 (JP) 2024-209583

(51) Int. Cl. E02F 9/22; F15B 15/18; F15B 19/00

(52) U.S. Cl. CPC E02F 9/2203; F15B 15/18; F15B 19/00

(57) ABSTRACT

A technique capable of appropriately controlling an electric motor that drives a hydraulic pump is provided. A hydraulic system S according to the present disclosure includes a hydraulic pump 32, a supply oil passage 58 that supplies hydraulic oil from the hydraulic pump 32 to a front loader 4 operated by hydraulic pressure, a pressure sensor 36 that detects a hydraulic pressure in the supply oil passage 58, a pump motor 30 that drives the hydraulic pump 32, a drive circuit 22a that controls the pump motor 30 by a control command based on a torque command value, and a processing device 18 that performs generation processing of generating the torque command value on the basis of a rotation speed of the pump motor 30 and an output of the pressure sensor 36.

### CROSS-REFERENCE TO RELATED APPLICATION

This application claims priority to Japanese Patent Application No. 2024-209583 filed Dec. 2, 2024, the disclosure of which is hereby incorporated by reference in its entirety.

### BACKGROUND OF THE INVENTION

### Field of the Invention

The present disclosure relates to a hydraulic system, a work vehicle, a control method, and a computer program.

### Description of Related Art

Japanese Laid-Open Patent Publication No. 2024-96596 discloses a work vehicle. The work vehicle includes a working device that moves up and down by hydraulic pressure. A hydraulic system that operates the working device includes a hydraulic cylinder and a hydraulic pump that generates hydraulic pressure supplied to the hydraulic cylinder. This hydraulic pump is driven by an electric motor (see, for example, Japanese Laid-Open Patent Publication No. 2024-96596).

In the above hydraulic system, a load from the outside acts on the hydraulic cylinder in accordance with the operation of the working device, and a sudden fluctuation in hydraulic pressure may occur.

When a sudden fluctuation in hydraulic pressure occurs, an electric motor that drives a hydraulic pump that generates hydraulic pressure is also affected.

That is, when a sudden fluctuation in hydraulic pressure occurs, a load acting on the electric motor also fluctuates.

When the load fluctuation caused by a sudden fluctuation in hydraulic pressure acts on the electric motor, the deviation between the rotation speed of the electric motor and a target rotation speed increases, and as a result, overshoot or undershoot with respect to a target value occurs in the output torque and the rotation speed of the electric motor, which causes damage of the hydraulic pump and discomfort at the time of operating the working device.

### SUMMARY OF THE INVENTION

In view of the foregoing, an object of the present disclosure is to provide a technique capable of appropriately controlling an electric motor that drives a hydraulic pump even when a sudden fluctuation in hydraulic pressure occurs.

A hydraulic system according to the present disclosure includes a hydraulic pump, a supply oil passage that supplies hydraulic oil from the hydraulic pump to a working device operated by hydraulic pressure, a sensor that detects a hydraulic pressure in the supply oil passage, an electric motor that drives the hydraulic pump, a drive circuit that controls the electric motor by a control command based on a torque command value, and a processing device that performs generation processing of generating the torque command value on a basis of a rotation speed of the electric motor and an output of the sensor.

According to the present disclosure, it is possible to appropriately control an electric motor that drives a hydraulic pump.

### BRIEF DESCRIPTION OF THE DRAWINGS

FIG. 1 is a side view of a work vehicle according to an embodiment.

FIG. 2 is a block diagram illustrating an example of a power system of a work vehicle.

FIG. 3 is a block diagram illustrating an example of a hydraulic system of a work vehicle.

FIG. 4 is a block diagram illustrating an example of processing content executed by a processing device.

FIG. 5 is a diagram illustrating an example of a graph illustrating a relationship between a hydraulic pressure value of a supply oil passage and a second command value.

FIG. 6 is a diagram illustrating an example of a change in the second command value when the hydraulic pressure value of the supply oil passage changes.

FIG. 7 is a diagram illustrating an example of a change in motor torque of a pump motor and a change in rotation speed of the pump motor when the hydraulic pressure value of the supply oil passage changes as illustrated in FIG. 6.

FIG. 8A is a diagram illustrating another example of a graph illustrating a relationship between the hydraulic pressure value of the supply oil passage and the second command value.

FIG. 8B is a diagram illustrating still another example of a graph illustrating the relationship between the hydraulic pressure value of the supply oil passage and the second command value.

### DESCRIPTION OF THE INVENTION

First, contents of the embodiments will be listed and described.

### [Outline of Embodiments]

(1) A hydraulic system according to the present disclosure includes a hydraulic pump, a supply oil passage that supplies hydraulic oil from the hydraulic pump to a working device operated by hydraulic pressure, a sensor that detects a hydraulic pressure in the supply oil passage, an electric motor that drives the hydraulic pump, a drive circuit that controls the electric motor by a control command based on a torque command value, and a processing device that performs generation processing of generating the torque command value on a basis of a rotation speed of the electric motor and an output of the sensor.

With the above configuration, since the torque command value is generated according to the hydraulic pressure in the supply oil passage in addition to the rotation speed of the electric motor, when a sudden hydraulic pressure fluctuation occurs in the supply oil passage due to operation of the working device, the hydraulic pressure fluctuation can be reflected in the torque command value before the influence of the hydraulic pressure fluctuation appears in the rotation speed of the electric motor.

As a result, the followability of the torque command value with respect to the hydraulic pressure fluctuation of the supply oil passage can be enhanced, and the electric motor can be appropriately controlled even if the load fluctuation caused by the sudden hydraulic pressure fluctuation acts on the electric motor.

(2) In the hydraulic system of (1), the generation processing may include processing of calculating a first command value on a basis of a target rotation speed and the rotation speed, processing of calculating a second command value according to the output of the sensor, and addition processing of obtaining the torque command value by adding the first command value and the second command value.

In this case, the hydraulic pressure fluctuation in the supply oil passage is quickly reflected in the second command value. Thus, the followability of the torque command value with respect to the hydraulic pressure fluctuation of the supply oil passage is enhanced.

(3) In the hydraulic system of (2), the second command value may be larger as the hydraulic pressure value of the supply oil passage indicated by the output of the sensor is larger.

In this case, the second command value can be increased or decreased according to the increase or decrease of the hydraulic pressure value of the supply oil passage.

(4) In the hydraulic system of (1), the generation processing may include processing of selecting, on a basis of the output of the sensor, which of processing of setting a first command value based on a target rotation speed and the rotation speed as the torque command value and processing of obtaining the torque command value by adding the first command value and a predetermined second command value is to be executed.

In this case, when the hydraulic pressure value obtained by the output of the sensor reaches a value that causes a relatively high load on the electric motor, the hydraulic pressure fluctuation can be reflected in the torque command value before the influence of the hydraulic pressure fluctuation appears in the rotation speed.

As a result, the electric motor that drives the hydraulic pump can be appropriately controlled.

(5) From another point of view, the present disclosure is a work vehicle. The work vehicle includes a working device that operates by hydraulic pressure, and the hydraulic system according to any one of (1) to (4).

(6) Further, the present disclosure viewed from another viewpoint is a control method for an electric motor. This control method is a control method for an electric motor that drives a hydraulic pump for supplying hydraulic oil to a working device. The control method includes acquiring an output of a sensor that detects a hydraulic pressure in a supply oil passage for supplying the hydraulic oil from the hydraulic pump to the working device, generating a torque command value on a basis of a rotation speed of the electric motor and an output of the sensor, and providing a control command based on the torque command value to a drive circuit that controls the electric motor. (7) Furthermore, the present disclosure viewed from another viewpoint is a computer program. This computer program is a computer program for causing a computer to execute control of an electric motor that drives a hydraulic pump for supplying hydraulic oil to a working device. This computer program causes a computer to execute acquiring an output of a sensor that detects a hydraulic pressure in a supply oil passage for supplying the hydraulic oil from the hydraulic pump to the working device, generating a torque command value on a basis of a rotation speed of the electric motor and an output of the sensor, and providing a control command based on the torque command value to a drive circuit that controls the electric motor.

### [Details of Embodiment]

Hereinafter, a preferred embodiment will be described with reference to the drawings.

Note that at least some of the embodiments described below may be arbitrarily combined.

### [Overall Configuration of Work Vehicle]

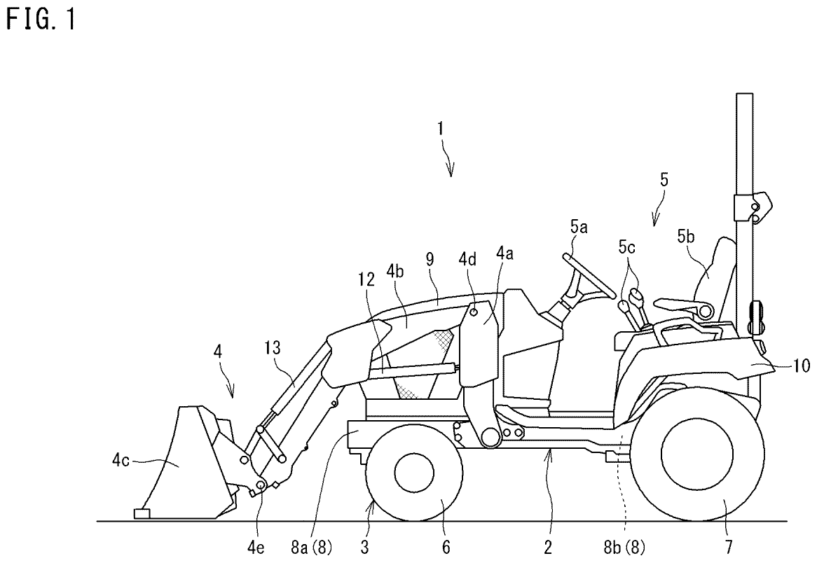

FIG. 1 is a side view of a work vehicle according to an embodiment.

The work vehicle 1 is a vehicle used for farmwork, specifically, a tractor. However, the work vehicle 1 is not limited to the tractor, and may be a mobile object such as an agricultural machine, a construction machine, or a utility vehicle.

As illustrated in FIG. 1, the work vehicle 1 includes a vehicle body 2, a traveling mechanism 3, a front loader 4, a driving unit 5, and the like.

The traveling mechanism 3 includes a pair of left and right front wheels 6 and a pair of left and right rear wheels 7. The front and rear wheels 6 and 7 are rotatably provided on an axle provided on the vehicle body 2. The traveling mechanism 3 has a function of transmitting driving force from a traveling motor 24 described later to the front and rear wheels 6 and 7 to rotationally drive the front and rear wheels 6 and 7. Thus, the traveling mechanism 3 includes a transmission mechanism (not illustrated) that transmits the driving force to the front and rear wheels 6 and 7 in addition to the front and rear wheels 6 and 7. The transmission mechanism includes rotating shafts such as a drive shaft and a propeller shaft, a differential device, a transmission device, and the like.

The vehicle body 2 includes a chassis 8, a hood 9, a fender 10, and the like. The chassis 8 includes a frame 8a and a transmission case 8b. The frame 8a and the transmission case 8b are connected to each other. The front wheels 6 are provided on the frame 8a, and the rear wheels 7 are provided on the transmission case 8b. Each unit of the work vehicle 1 such as the traveling mechanism 3, the driving unit 5, and the front loader 4 is mounted on the chassis 8.

The hood 9 is provided at a front portion of the vehicle body 2. The fender 10 is provided above the rear wheels 7.

The driving unit 5 is provided at a rear portion of the vehicle body 2. The driving unit 5 includes a steering wheel 5a, a driver's seat 5b, an operation lever 5c, and the like. The driver's seat 5b is a seat on which a worker who drives the work vehicle 1 sits. The steering wheel 5a is a steering wheel for steering the front wheels 6. The operation lever 5c includes a lever for adjusting the speed of the work vehicle 1, an operation lever of the front loader 4, and the like.

The operation lever 5c has a function of receiving an operation input of an operator. The operation lever 5c provides an output corresponding to the received operation input to the operation control unit 16 (described later).

The front loader 4 is a working device provided at a front portion of the vehicle body 2. The front loader 4 includes a pair of left and right frames 4a, a pair of left and right arms 4b, a bucket 4c, a pair of left and right arm cylinders 12, a pair of left and right bucket cylinders 13, and the like.

The frame 4a is provided on the left and right sides of the hood 9. The frame 4a is fixed to the frame 8a.

The arm 4b connects the frame 4a and the bucket 4c. The rear end of the arm 4b and the frame 4a are connected to each other by a shaft 4d. The axial direction of the shaft 4d is along a left-right direction. The arm 4b is swingable about the shaft portion 4d.

The front end of the arm 4b and the bucket 4c are connected to each other by a shaft 4e. The axial direction of the shaft 4e is along the left-right direction. The bucket 4c is swingable around the shaft 4e.

The pair of arm cylinders 12 is connected to the pair of frames 4a and the pair of arms 4b. When the arm cylinder 12 expands and contracts, the arm 4b swings in the vertical direction around the shaft portion 4d.

The pair of bucket cylinders 13 is connected to the pair of arms 4b and the bucket 4c. When the bucket cylinder 13 expands and contracts, the bucket 4c swings around the shaft 4e.

The pair of arm cylinders 12 and the pair of bucket cylinders 13 expand and contract in accordance with the operation of the operation lever 5c.

### [Power System of Work Vehicle]

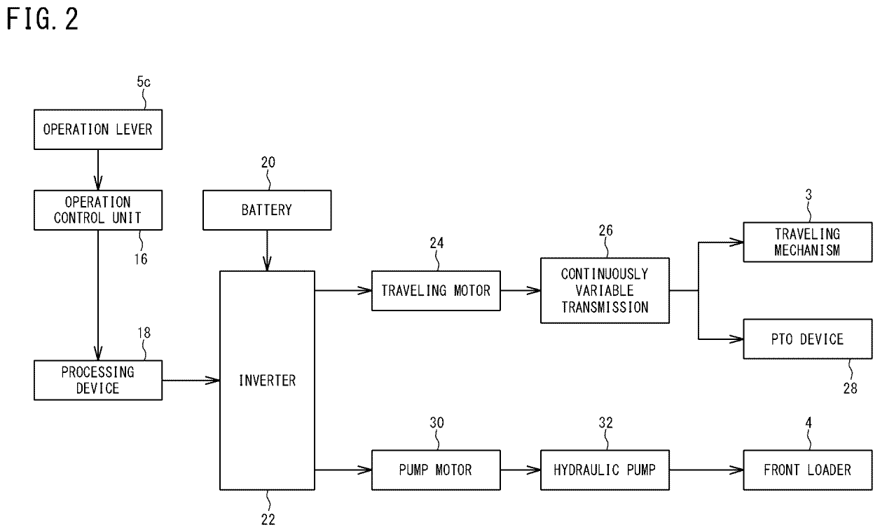

FIG. 2 is a block diagram illustrating an example of a power system of the work vehicle 1.

As illustrated in FIG. 2, the work vehicle 1 further includes an operation control unit 16, a processing device 18, a battery 20, an inverter 22, a traveling motor 24, a continuously variable transmission 26, a PTO device 28, a pump motor 30, a hydraulic pump 32, and the like.

The work vehicle 1 of the present embodiment is configured to generate hydraulic pressure by the driving force of the traveling motor 24 and the pump motor 30, and operate the traveling mechanism 3 and the front loader 4 by the hydraulic pressure.

The traveling motor 24 and the pump motor 30 are electric motors, and output rotational force by electric power stored in the battery 20.

The driving force by the traveling motor 24 is transmitted to the continuously variable transmission 26. The continuously variable transmission 26 is a hydrostatic continuously variable transmission. The continuously variable transmission 26 can continuously change the driving force from the traveling motor 24. The continuously variable transmission 26 can be operated by a worker.

The continuously variable transmission 26 varies the driving force from the traveling motor 24, and transmits the varied driving force to the traveling mechanism 3 and the PTO device 28.

The traveling mechanism 3 drives the front and rear wheels 6 and 7 by the driving force transmitted from the continuously variable transmission 26.

The PTO device 28 outputs the driving force transmitted from the continuously variable transmission 26 to, for example, a working device attached to the work vehicle 1. A clutch that interrupts the driving force is provided between the continuously variable transmission 26 and the PTO device 28. The driving force from the continuously variable transmission 26 is transmitted to the PTO device 28 by the clutch as necessary.

Note that the traveling motor 24 is disposed in the front portion of the vehicle body 2 and inside the hood 9. The continuously variable transmission 26 and the PTO device 28 are housed in the transmission case 8b. The driving force of the traveling motor 24 is transmitted to the continuously variable transmission 26 via a transmission shaft or the like.

The driving force of the pump motor 30 is transmitted to the hydraulic pump 32. The hydraulic pump 32 supplies hydraulic oil to the arm cylinder 12 and the bucket cylinder 13 of the front loader 4. The hydraulic oil is lubricating oil stored in the transmission case 8b. Thus, the hydraulic pump 32 is provided in the transmission case 8b. The hydraulic pump 32 is driven by the driving force of the pump motor 30, sucks the hydraulic oil in the transmission case 8b, and pressure-feeds the sucked hydraulic oil to the arm cylinder 12 and the bucket cylinder 13 of the front loader 4.

The inverter 22 supplies electric power from the battery 20 to the traveling motor 24 and the pump motor 30. The inverter 22 includes a drive circuit connected to the traveling motor 24 and a drive circuit connected to the pump motor 30. These drive circuits supply electric power from the battery 20 to the traveling motor 24 and the pump motor 30 on the basis of a control command from the processing device 18, and control the traveling motor 24 and the pump motor 30.

The processing device 18 has a function of controlling the traveling motor 24 and the pump motor 30 by providing a control command to the drive circuit. The processing device 18 performs feedback control so that the traveling motor 24 and the pump motor 30 operate at their target rotation speeds. The processing device 18 is provided with outputs of rotation sensors that detect respective rotation speeds of the traveling motor 24 and the pump motor 30. The processing device 18 obtains a control command on the basis of the rotation speeds of the traveling motor 24 and the pump motor 30 and the target rotation speed. The target rotation speed is obtained by the operation control unit 16.

The operation control unit 16 obtains the target rotation speed on the basis of the output provided from the operation lever 5c and provides the target rotation speed to the processing device 18.

Therefore, the operation control unit 16 obtains the target rotation speed corresponding to the operation of the work vehicle 1 requested by the worker.

### [Hydraulic System]

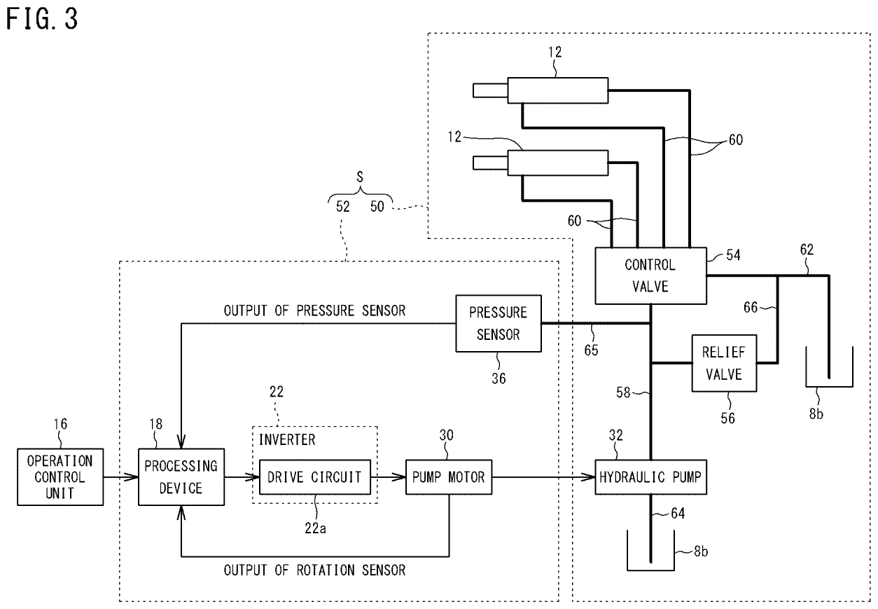

FIG. 3 is a block diagram illustrating an example of a hydraulic system of the work vehicle 1. Note that, in FIG. 3, the bucket cylinder 13 is omitted from the arm cylinder 12 and the bucket cylinder 13 of the front loader 4 for easy understanding.

In FIG. 3, the hydraulic system S includes an oil circulation circuit 50 and a pump control device 52.

The oil circulation circuit 50 is a circuit for circulating the differential oil in the transmission case 8b and supplying and discharging the hydraulic oil to and from the arm cylinder 12. In addition to the hydraulic pump 32, the pair of arm cylinders 12, and the transmission case 8b described above, the oil circulation circuit 50 includes a control valve 54, a relief valve 56, a supply oil passage 58, four supply-discharge oil passages 60, a return oil passage 62, a suction oil passage 64, and the like.

The hydraulic pump 32 sucks the hydraulic oil in the transmission case 8b from the suction oil passage 64 and discharges the hydraulic oil to the supply oil passage 58. The supply oil passage 58 connects the hydraulic pump 32 and the control valve 54. The hydraulic pump 32 pressure-feeds hydraulic oil to the control valve 54 via the supply oil passage 58.

The control valve 54 is connected to the pair of arm cylinders 12 via four supply-discharge oil passages 60. The control valve 54 has a function of performing supply/discharge control of hydraulic oil to/from the pair of arm cylinders 12 on the basis of a command from the operation control unit 16 or the like. The pair of arm cylinders 12 extends and contracts by supply/discharge control of hydraulic oil by the control valve 54. Therefore, the pair of arm cylinders 12 expands and contracts in accordance with an operation input to the operation lever 5c by the worker.

Further, the return oil passage 62 is connected to the control valve 54. The hydraulic oil discharged from the pair of arm cylinders 12 is returned to the transmission case 8b through the control valve 54 and the return oil passage 62.

In this manner, the oil circulation circuit 50 circulates the hydraulic oil in the transmission case 8b.

The relief valve 56 is provided in a bypass oil passage 66. The bypass oil passage 66 connects the supply oil passage 58 and the return oil passage 62. The relief valve 56 closes when a hydraulic pressure value of the hydraulic oil in the supply oil passage 58 is lower than a preset valve opening pressure, thereby closing the bypass oil passage 66. The relief valve 56 opens when the hydraulic pressure value of the hydraulic oil in the supply oil passage 58 is equal to or higher than a preset valve opening pressure, thereby opening the bypass oil passage 66. Thus, the relief valve 56 sets an upper limit value of the hydraulic pressure value of the supply oil passage 58. That is, the valve opening pressure of the relief valve 56 is the upper limit value of the hydraulic pressure value in the supply oil passage 58.

The pump control device 52 has a function of controlling the pump motor 30 and controlling the operation of the hydraulic pump 32. The pump control device 52 includes a pressure sensor 36 and the like in addition to the processing device 18, a drive circuit 22a of the inverter 22, and the pump motor 30 described above.

The drive circuit 22a is a drive circuit that controls the pump motor 30 among the drive circuits included in the inverter 22.

The pressure sensor 36 is provided in a branch oil passage 65 connected to the supply oil passage 58. The pressure sensor 36 has a function of detecting the hydraulic pressure of the hydraulic oil in the supply oil passage 58 via the branch oil passage 65. The output of the pressure sensor 36 is provided to the processing device 18.

The processing device 18 is configured by a computer or the like including a processing unit, a storage unit, and the like.

The processing unit is, for example, various processors adapted to control of a computer, such as a central processing unit (CPU), a graphics processing unit (GPU), a digital signal processor (DSP), and a field programmable gate array (FPGA).

The storage unit includes, for example, a flash memory, a hard disk, a solid state drive (SSD), a read only memory (ROM), and the like.

The storage unit stores a computer program to be executed by the processing unit and necessary information. The processing unit implements various processing functions of the processing device 18 by executing a computer program stored in a computer-readable non-transitory recording medium such as a storage unit.

The target rotation speed from the operation control unit 16, the output of the rotation sensor, and the output of the pressure sensor 36 are provided to the processing device 18.

The rotation sensor includes, for example, a Hall element included in the pump motor 30, a rotation sensor attached to the pump motor 30 and detecting a rotation speed of the pump motor 30, and the like.

The processing device 18 has a function of obtaining a control command to be provided to the drive circuit 22a on the basis of the output of the rotation sensor and the output of the pressure sensor 36.

### [Processing Performed by Processing Device]

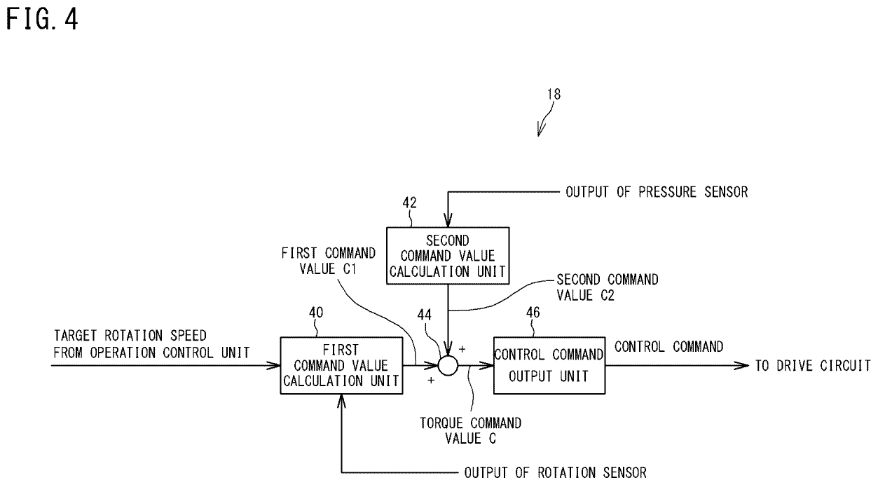

FIG. 4 is a block diagram illustrating an example of processing content executed by the processing device 18.

As illustrated in FIG. 4, the processing device 18 functionally includes a first command value calculation unit 40, a second command value calculation unit 42, an adder 44, and a control command output unit 46.

The first command value calculation unit 40 obtains a first command value C1 on the basis of the target rotation speed and the output of the rotation sensor. The first command value C1 is a command value (current command value) related to torque control of the pump motor 30. The first command value calculation unit 40 obtains the rotation speed of the pump motor 30 on the basis of the output of the rotation sensor. The first command value calculation unit 40 performs PID control on the basis of a difference between the target rotation speed and the rotation speed. The first command value calculation unit 40 obtains the first command value C1 by calculation based on the PID control.

The second command value calculation unit 42 obtains a second command value C2 on the basis of the output of the pressure sensor 36. The second command value C2 is a command value (current command value) related to torque control of the pump motor 30. The storage unit of the processing device 18 stores data indicating a relationship between a value (hydraulic pressure value) indicating the hydraulic pressure in the supply oil passage 58 and the second command value C2.

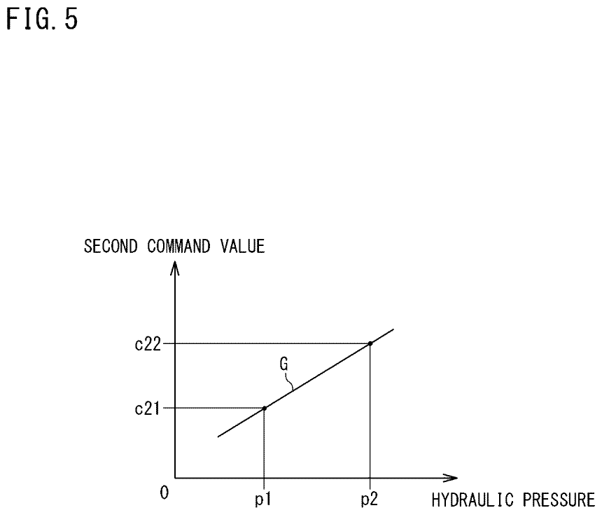

FIG. 5 is a diagram illustrating an example of data indicating the relationship between the hydraulic pressure value of the supply oil passage 58 and the second command value C2. The processing device 18 of the present embodiment stores data indicating the relationship between the hydraulic pressure value and the second command value C2 as a graph.

In FIG. 5, the horizontal axis represents the hydraulic pressure value. The vertical axis represents the second command value. In FIG. 5, a graph G is a straight line. That is, the hydraulic pressure value and the second command value have a linear relationship.

Further, in FIG. 5, when the hydraulic pressure value is a value p1, the second command value C2 is a value c21, and when the hydraulic pressure value is a value p2 larger than the value p1, the second command value C2 is a value c22 larger than the value c21. Thus, the second command value C2 increases as the hydraulic pressure value of the supply oil passage 58 increases.

The relationship between the hydraulic pressure value and the second command value C2 is set to an appropriate numerical relationship by a preliminary experiment.

Data indicating the relationship between the hydraulic pressure value of the supply oil passage 58 and the second command value C2 may be obtained in advance on the basis of simulation or the like, or may be obtained by performing an experiment using the work vehicle 1.

In addition, the processing device 18 can also store data indicating the relationship between the hydraulic pressure value of the supply oil passage 58 and the second command value C2 as a table, a mathematical formula, or the like.

The second command value calculation unit 42 obtains a hydraulic pressure value on the basis of the output of the pressure sensor 36, refers to data indicating a relationship between the hydraulic pressure value stored in the storage unit and the second command value C2, and obtains the second command value C2 according to the output of the pressure sensor 36.

The first command value C1 and the second command value C2 are provided to the adder 44. The adder 44 adds the first command value C1 and the second command value C2 to obtain the torque command value C. That is, the torque command value C is expressed by the following formula.

Torque command value C=first command value C1+second command value C2

The torque command value C is a value (current command value) indicating the torque to be output from the pump motor 30. In this manner, the processing device 18 executes processing (generation processing) of generating the torque command value C on the basis of the rotation speed of the pump motor 30 and the output of the pressure sensor 36. The torque command value C is provided to the control command output unit 46.

The control command output unit 46 generates a control command on the basis of the torque command value C.

The control command is provided to the drive circuit 22a of the inverter 22. The drive circuit 22a controls the pump motor 30 on the basis of the control command. Thus, the pump motor 30 is controlled on the basis of the torque command value C including the first command value C1 and the second command value C2.

According to the present embodiment, since the processing device 18 generates the torque command value C according to the hydraulic pressure value indicated by the output of the pressure sensor 36 in addition to the rotation speed of the pump motor 30, when a sudden hydraulic pressure fluctuation occurs in the supply oil passage 58 due to the operation of the front loader 4, the hydraulic pressure fluctuation can be reflected in the torque command value C before the influence of the hydraulic pressure fluctuation appears in the rotation speed of the pump motor 30.

As a result, followability of the torque command value C with respect to the hydraulic pressure fluctuation of the supply oil passage 58 can be enhanced, and even if the load fluctuation caused by the sudden hydraulic pressure fluctuation acts on the pump motor 30, the pump motor 30 can be appropriately controlled.

Further, the generation processing performed by the processing device 18 includes processing (first command value calculation unit 40) of calculating the first command value C1 on the basis of the target rotation speed and the rotation speed of the pump motor 30, processing (second command value calculation unit 42) of calculating the second command value C2 according to the output of the pressure sensor 36, and addition processing (adder 44) of obtaining the torque command value C by adding the first command value C1 and the second command value C2, so that the hydraulic pressure fluctuation of the supply oil passage 58 is quickly reflected in the second command value C2. Therefore, followability of the torque command value C with respect to the hydraulic pressure fluctuation of the supply oil passage 58 is enhanced.

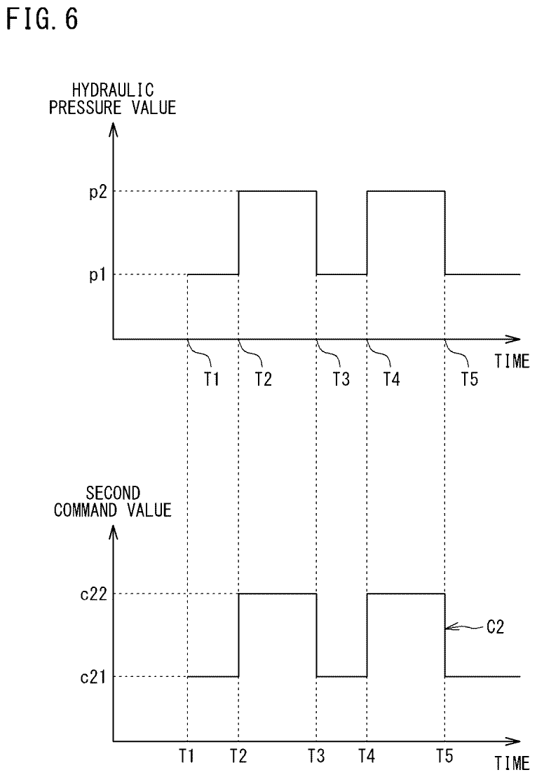

FIG. 6 is a diagram illustrating an example of a change in the second command value C2 when the hydraulic pressure value of the supply oil passage 58 changes.

In FIG. 6, the upper graph illustrates a change in the hydraulic pressure value of the supply oil passage 58. In the upper graph, the horizontal axis represents time, and the vertical axis represents a hydraulic pressure value. Further, the lower graph indicates a change in the second command value C2. The horizontal axis of the lower graph represents time, and the vertical axis represents the second command value C2. The horizontal axis of the upper graph and the horizontal axis of the lower graph are associated with each other.

In FIG. 6, the hydraulic pressure value from time T1 to time T2 is the value p1. When the time reaches the time T2, the hydraulic pressure value rapidly increases to the value p2. Note that the value p2 is an upper limit value of the hydraulic pressure value of the supply oil passage 58. That is, the value p2 is the valve opening pressure of the relief valve 56.

The hydraulic pressure value from the time T2 to time T3 maintains the value p2. When the time reaches the time T3, the hydraulic pressure value rapidly decreases to the value p1.

In the period from the time T1 to the time T2, no soil is loaded on the bucket 4c. Therefore, the hydraulic pressure value is constant at the value p1 lower than the value p2.

In a period from the time T2 to the time T3, soil or the like is loaded on the bucket 4c, so that a load acts on the pair of arm cylinders 12 and the pair of bucket cylinders 13. Therefore, at the time T2, which is the timing when the load acts, the hydraulic pressure value rapidly increases. Further, the hydraulic pressure value in the period from the time T2 to the time T3 is constant at the value p2 (upper limit value). At the time T3, which is the timing at which the load is released, the hydraulic pressure value rapidly decreases.

The hydraulic pressure value indicates a change similar to the change from the time T1to the time T3 even between the time T3 and the time T5.

The processing device 18 obtains the second command value C2 on the basis of the data illustrated in FIG. 5. The processing device 18 sets the second command value C2 when the hydraulic pressure value is the value p1 as the value c21, and sets the second command value C2 when the hydraulic pressure value is the value p2 as the value c22.

Thus, as illustrated in FIG. 6, the second command value C2 increases or decreases according to the increase or decrease of the hydraulic pressure value.

The second command value C2 is added to the first command value C1 to become the torque command value C. Therefore, at the time T2 and time T4, the torque command value C rapidly increases as the second command value C2 increases. As a result, the torque command value C can be increased according to the hydraulic pressure fluctuation before the influence of the sudden hydraulic pressure fluctuation generated in the supply oil passage 58 appears in the rotation speed of the pump motor 30.

As a result, even if a load fluctuation caused by a sudden hydraulic pressure fluctuation acts on the pump motor 30, the pump motor 30 can be appropriately controlled.

Note that the first command value C1 is obtained by feedback control based on the rotation speed of the pump motor 30. Therefore, the first command value C1 is obtained as a value corresponding to the torque command value C including the second command value C2.

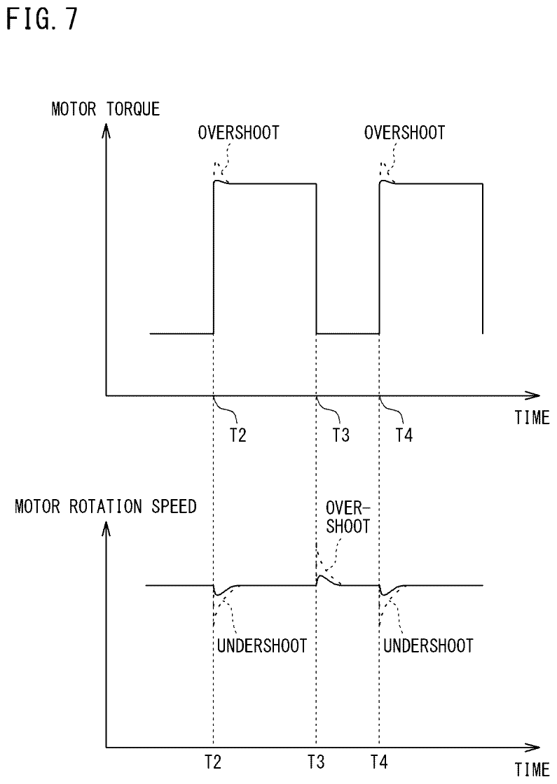

FIG. 7 is a diagram illustrating an example of a change in the motor torque of the pump motor 30 and a change in the rotation speed of the pump motor 30 when the hydraulic pressure value of the supply oil passage 58 changes as illustrated in FIG. 6.

In FIG. 7, the upper graph illustrates a change in motor torque. The horizontal axis of the upper graph represents time, and the vertical axis represents motor torque. Further, the lower graph illustrates a change in the rotation speed of the pump motor 30. The horizontal axis of the lower graph represents time, and the vertical axis represents rotation speed. The horizontal axis of the upper graph and the horizontal axis of the lower graph are associated with each other.

As illustrated in FIG. 7, the motor torque rapidly increases at the time T2 and the time T4, and rapidly decreases at time T3.

Further, the rotation speed of the pump motor 30 instantaneously decreases at times T2 and T4, and instantaneously increases at time T3.

For example, when the pump motor 30 is controlled only by the first command value C1, an overshoot as indicated by a broken line is remarkably generated at times T2, T3, and T4.

However, when the pump motor 30 is controlled by the torque command value C obtained by adding the first command value C1 and the second command value C2 as in the present embodiment, the overshoot is alleviated as indicated by the solid graph in FIG. 7.

As a result, it is possible to suppress breakage of the hydraulic pump and discomfort at the time of operating the front loader 4.

### [Modification]

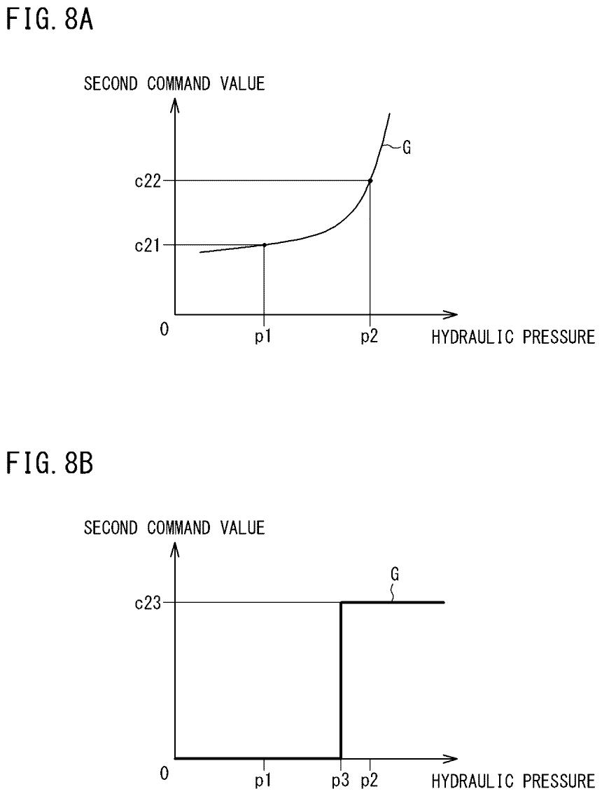

FIG. 8A is a graph illustrating another example of the relationship between the hydraulic pressure value of the supply oil passage 58 and the second command value C2.

FIG. 8A is different from the above embodiment in that the graph G is a curve. The graph G of the present modification is a curve in which the inclination increases as the hydraulic pressure value increases. Further, the graph G has a shape that rapidly rises in the vicinity of the value p2 which is the upper limit value of the hydraulic pressure value. Thus, in the present modification, the change in the torque command value C is suppressed by reducing the change in the second command value C2 with respect to the hydraulic pressure value in the range where the hydraulic pressure value is relatively low, and the change in the second command value C2 with respect to the hydraulic pressure value increases in the range where the hydraulic pressure value is relatively high. Thus, the followability of the torque command value C with respect to the hydraulic pressure fluctuation of the supply oil passage 58 can be further enhanced.

FIG. 8B is a graph illustrating still another example of the relationship between the hydraulic pressure value of the supply oil passage 58 and the second command value C2.

The graph G of FIG. 8B is different from that of the above embodiment in that the second command value C2 in the range where the hydraulic pressure value is 0 to a value p3 is 0, and the second command value C2 in the range where the hydraulic pressure value is equal to or higher than p3 is a value c23. The value p3 is higher than the value p1 and slightly lower than the value p2 that is the upper limit of the hydraulic pressure value.

In the present modification, the second command value C2 is 0 in a range where the hydraulic pressure value is smaller than the value p3. Thus, in a range where the hydraulic pressure value is smaller than the value p3, the processing device 18 sets the first command value C1 as the torque command value C.

On the other hand, in the range where the hydraulic pressure value is equal to or higher than the value p3, the second command value C2 is the value c23. Therefore, in the range where the hydraulic pressure value is equal to or higher than the value p3, the processing device 18 adds the first command value C1 and the value c23 that is the second command value C2 to obtain the torque command value C.

As described above, in the present modification, which of the processing of setting the first command value C1 as the torque command value C and the processing of obtaining the torque command value C by adding the first command value C1 and the second command value C2 is executed is selected on the basis of the output of the pressure sensor 36.

In the present modification, when the hydraulic pressure value rises to the value p3, the hydraulic pressure fluctuation can be reflected in the torque command value C before the influence of the hydraulic pressure fluctuation appears in the rotation speed. As a result, the pump motor 30 can be appropriately controlled.

In addition, in the present modification, since the hydraulic pressure value when the second command value C2 transitions from 0 to the value c23 is set to the value p3 lower than the upper limit value (value p2), the second command value C2 can be set to the value c23 before the hydraulic pressure value reaches the value p2, and the followability of the torque command value C to the hydraulic pressure fluctuation of the supply oil passage 58 can be further enhanced.

### [Others]

It should be understood that the embodiments disclosed herein are illustrative in all respects and are not restrictive.

For example, in the present embodiment, the case where the working device included in the work vehicle 1 is the front loader 4 has been exemplified, but a backhoe may be used as a working device operated by hydraulic pressure, or both the front loader and the backhoe may be provided.

The scope of the present invention is indicated not by the above meaning but by the claims, and is intended to include meanings equivalent to the claims and all modifications within the scope.

### REFERENCE SIGNS LIST

1 work vehicle
2 vehicle body
3 traveling mechanism
4 front loader
4a frame
4b arm
4c bucket
4d shaft portion
4e shaft portion
5 driving unit
5a steering wheel
5b driver's seat
5c operation lever
6 front wheel
7 rear wheel
8 chassis
8a frame
8b transmission case
9 hood
10 fender
12 arm cylinder
13 bucket cylinder
16 operation control unit
18 processing device
20 battery
22 inverter
22a drive circuit
24 traveling motor
26 continuously variable transmission
28 PTO device
30 pump motor
32 hydraulic pump
36 pressure sensor
40 first command value calculation unit
42 second command value calculation unit
44 adder
46 control command output unit
50 oil circulation circuit
52 pump control device
54 control valve
56 relief valve
58 supply oil passage
60 supply-discharge oil passage
62 return oil passage
64 suction oil passage
65 branch oil passage
66 bypass oil passage
C torque command value
C1 first command value
C2 second command value
G graph
S hydraulic system

1. A hydraulic system comprising:
a hydraulic pump;
a supply oil passage that supplies hydraulic oil from the hydraulic pump to a working device operated by hydraulic pressure;
a sensor that detects a hydraulic pressure in the supply oil passage;
an electric motor that drives the hydraulic pump;
a drive circuit that controls the electric motor by a control command based on a torque command value; and
a processing device that performs generation processing of generating the torque command value on a basis of a rotation speed of the electric motor and an output of the sensor.

2. The hydraulic system according to claim 1, wherein:
the generation processing comprises:
processing of calculating a first command value on a basis of a target rotation speed and the rotation speed;
processing of calculating a second command value according to the output of the sensor; and
addition processing of obtaining the torque command value by adding the first command value and the second command value.

3. The hydraulic system according to claim 2, wherein:
the second command value is larger as the hydraulic pressure value of the supply oil passage indicated by the output of the sensor is larger.

4. The hydraulic system according to claim 1, wherein:
the generation processing comprises processing of selecting, on a basis of the output of the sensor, which of processing of setting a first command value based on a target rotation speed and the rotation speed as the torque command value and processing of obtaining the torque command value by adding the first command value and a predetermined second command value is to be executed.

5. A work vehicle comprising:
a working device that operates by hydraulic pressure; and
the hydraulic system according to claim 1.

6. A control method for an electric motor that drives a hydraulic pump for supplying hydraulic oil to a working device, the method comprising:
acquiring an output of a sensor that detects a hydraulic pressure in a supply oil passage for supplying the hydraulic oil from the hydraulic pump to the working device;
generating a torque command value on a basis of a rotation speed of the electric motor and an output of the sensor; and
providing a control command based on the torque command value to a drive circuit that controls the electric motor.

7. A non-transitory computer readable storage medium storing a computer program for causing a computer to execute control of an electric motor that drives a hydraulic pump for supplying hydraulic oil to a working device, the computer program causing the computer to execute:
acquiring an output of a sensor that detects a hydraulic pressure in a supply oil passage for supplying the hydraulic oil from the hydraulic pump to the working device;
generating a torque command value on a basis of a rotation speed of the electric motor and an output of the sensor; and
providing a control command based on the torque command value to a drive circuit that controls the electric motor.
